(19) United States
(12) Patent Application Publication
(10) Pub. No.: US 2016/0117467 A1
(43) Pub. Date: Apr. 28, 2016

(54) SYSTEM AND METHOD FOR AUTOMATICALLY GENERATING A HISTORICAL HEALTH TREND GRAPH FOR A PATIENT

(71) Applicant: True Health Diagnostics, LLC, Frisco, TX (US)

(72) Inventors: Satya Rangarajan, Richmond, VA (US); J. Michael D. Woodard, Richmond, VA (US); Charles Theodore Wise, Richmond, VA (US)

(21) Appl. No.: 14/984,716

(22) Filed: Dec. 30, 2015

Related U.S. Application Data
(63) Continuation of application No. 14/043,646, filed on Oct. 1, 2013.
(60) Provisional application No. 61/708,449, filed on Oct. 1, 2012.

(51) Int. Cl. G06F 19/00; G06T 11/20

(52) U.S. Cl. CPC G06F 19/3431; G06F 19/345; G06F 19/3487; G06F 19/366; G06T 11/206

(57) ABSTRACT

An application module configured to provide a historical graph report which plots a patient's diagnostic test result values over time, in which the historical graph is included in a customizable laboratory report. The historical graph is configured to show a patient or physician of any identifiable changes or trends that the patient has experienced with regard to his/her diagnostic text result values for one or more identified biomarkers. The application module may utilize unique graphical objects within the graph itself or with respect to individual cells in the chart to indicate the particular risk level that a corresponding test result value may be assigned to.

### PRIORITY CLAIM

This application is a continuation application of U.S. patent application Ser. No. 14/043.646 filed Oct. 1, 2013, which claims priority to U.S. Provisional Patent Application No. 61/708,449 filed Oct. 1, 2012, the contents of which are incorporated herein by reference and relied upon.

### FIELD

This technology relates to a system and method for automatically generating a historical health trend graph for a patient.

### BACKGROUND

Physicians commonly provide laboratory reports to patients in which the laboratory reports indicate results of one or more diagnostic tests that were performed on the patient. Many times, these reports also indicate whether the test result values of the diagnostic tests show that a particular biomarker is within a high, medium or low health risk level. However, there is currently no means to provide the patient with this information in a historical graphical form. Therefore, the patient has a way of determining when looking at the report, whether the values have improved or worsened since the last test was administered. The treating physician will make recommendations to the patient based on the results of the test. For instance, the patient may be advised to implement certain dietary restrictions or exercise programs. However, with only raw data presented in the report, the patient and/or treating physician has no easy way of understanding whether the recommendations are working.

Understanding how a patient is progressing is often times as important, if not more important, than the data itself. Therefore, what is needed is a system and method for automatically generating a historical health trend graph for a patient.

### SUMMARY

In an aspect, a method comprises receiving a first diagnostic test result value associated with a diagnostic test that is performed on a patient for a health relates issued at a first time period. The corresponding diagnostic test has a plurality of risk levels, wherein each risk level has an assigned preestablished range of diagnostic test result value boundaries. The method includes assigning the first diagnostic test result value to a first risk level. This is based on the first diagnostic test result value falling within a first range of preestablished test result values associated with the first risk level for the diagnostic test. The method includes receiving a second diagnostic test result value for the diagnostic test performed on the patient at a second time period, wherein the second time period subsequent to the first time period over a first time duration. The method includes assigning the second diagnostic test result value to a second risk level. This is based on the second diagnostic test result value falling within a second range of preestablished test result values associated with the second risk level for the diagnostic test. The method includes generating, using one or more processors, a reporting graph that illustrates one or more changes in the patient's diagnostic test result values of the health related issue tested by the diagnostic test over the first time period. This step further includes generating a first graphical point that is associated with the first test result value and a second graphical point that is associated with the second test result value in the reporting graph. The first and second graphical points are plotted in the reporting graph based on their respective time periods and corresponding diagnostic test result value. This step also includes generating a graphical connector in the reporting graph, wherein the graphical connector connects the first graphical point and the second graphical point over the first time duration on the report graph.

In an aspect, a method of graphically displaying the changes in a patient's diagnostic test results and corresponding risk levels over a period of time is disclosed. The method includes selecting, using one or more processors, a first diagnostic test result value for a patient. The first diagnostic test result value is associated with a corresponding diagnostic test performed on the patient for a health related issue at a first time period. The method includes determining, using the one or more processors, a risk level associated with the first diagnostic test result value, wherein the first diagnostic test result value is assigned to a corresponding risk level based on the value of the first diagnostic test result. The method includes selecting, using the one or more processors, a second diagnostic test result value for the diagnostic test performed on the patient at a second time period. The method includes determining, using the one or more processors, a risk level associated with the second diagnostic test result value, wherein the second diagnostic test result value is assigned to a corresponding risk level based on the value of the second diagnostic test result. The method includes generating, using the one or more processors, a laboratory results report for the patient. The laboratory results report includes a chart configured to include plurality of cells arranged in intersecting columns and rows, wherein at least the first and second diagnostic test result values are placed in corresponding cells of the chart and organized by their respective time periods and the corresponding health related issue tested for by the diagnostic test. The method includes generating, using the one or more processors, a reporting graph to be included in the chart. The reporting graph includes a first graphical point that is associated with the first diagnostic test result value and a second graphical point associated with the second diagnostic test result value. The first and second graphical points are plotted along a common time line and positioned relative to one another based on their corresponding values and time periods. The reporting graph includes a graphical connector connecting the first graphical point and the second graphical point between the first and second time periods, wherein the reporting graph indicates whether the patient's health related issue has changed over diagnostic test results and risk level between the first and second time periods.

In an aspect, a method comprises selecting, using one or more processors, a first diagnostic test result value for a patient. The first diagnostic test result value is associated with a corresponding diagnostic test performed on the patient for a health related issue at a first time period. The method includes determining, using the one or more processors, a risk level associated with the first diagnostic test result value, wherein the first diagnostic test result value is assigned to a corresponding risk level based on the value of the first diagnostic test result. The method includes selecting, using the one or more processors, a second diagnostic test result value for the diagnostic test performed on the patient at a second time period. The method includes determining, using the one or more processors, a risk level associated with the second diagnostic test result value, wherein the second diagnostic test result value is assigned to a corresponding risk level based on the value of the second diagnostic test result. The method includes generating, using the one or more processors, a laboratory results report for the patient. The laboratory results report includes a chart configured to include plurality of cells arranged intersecting columns and rows. At least the first and second diagnostic test result values are placed in corresponding cells of the chart and organized by their respective time periods and the corresponding health related issue tested for by the diagnostic test. The method includes displaying the first diagnostic test result value in a first cell of the chart and applying a first indicator object to the first cell, wherein the first indicator object is of a first color correlated with the first risk level.

### BRIEF DESCRIPTION OF THE DRAWINGS

FIG. 1 is a diagram of an example system environment that includes a computing device for automatically generating a historical health trend graph for a patient;

FIG. 2 is a block diagram of a computing device having an application module for automatically generating a historical health trend graph for a patient in FIG. 1;

FIG. 3A illustrates an example laboratory results report for a patient;

FIG. 3B illustrates a detailed view of the historical graph for a particular biomarker and a first type of indicator object of the chart illustrated in FIG. 3A;

FIG. 3C illustrates a detailed view of a second type of indicator object used in the chart illustrated in FIG. 3A;

FIG. 4 illustrates an example flow chart diagram depicting portions of processes performed by the application module;

FIG. 5 illustrates an example flow chart diagram depicting portion of processes performed by the application module.

While those examples are susceptible of embodiment in many different forms, there is shown in the drawings and will herein be described in detail preferred examples with the understanding that the present disclosure is to be considered as an exemplification and is not intended to limit the broad aspect to the aspects illustrated.

### DETAILED DESCRIPTION

In general, the application module 210 generates a laboratory report relating to a patient's health with regard to selected biomarkers for which diagnostic tests have been performed, and test result values have been obtained, for the patient. The application module 210 utilizes a user interface displayable via a computing device's screen which allows a user to enter and retrieve information. The user, such as a physician, patient, or staff, can request the application module 210 to provide a customized laboratory report showing diagnostic test result values for one or more user selected dates on which diagnostic tests were performed on the identified patient for one or more selected biomarkers. The application module 210 is thereafter able access one or more databases and retrieve the diagnostic test result values for the identified dates for each selected biomarker. The application module 210 is also able to process the test result values and compare them with preestablished reference result value ranges for each biomarker to identify whether test result values fall within an assigned risk level. The application module 210 is thereafter able to generate the laboratory report and organize the test result values, dates, biomarkers and available risk level in one or more cell-based charts. The application module 210 is also able to compile the test result values and their respective dates to generate a graph which plots the patient's test result values over time to show the changes or trends that the patient has experienced with regard to his/her test result values for each biomarker. The application module 210 may utilize unique graphical objects within the graph itself or with respect to individual cells in the chart to indicate the particular risk level that a corresponding test result value may be assigned to.

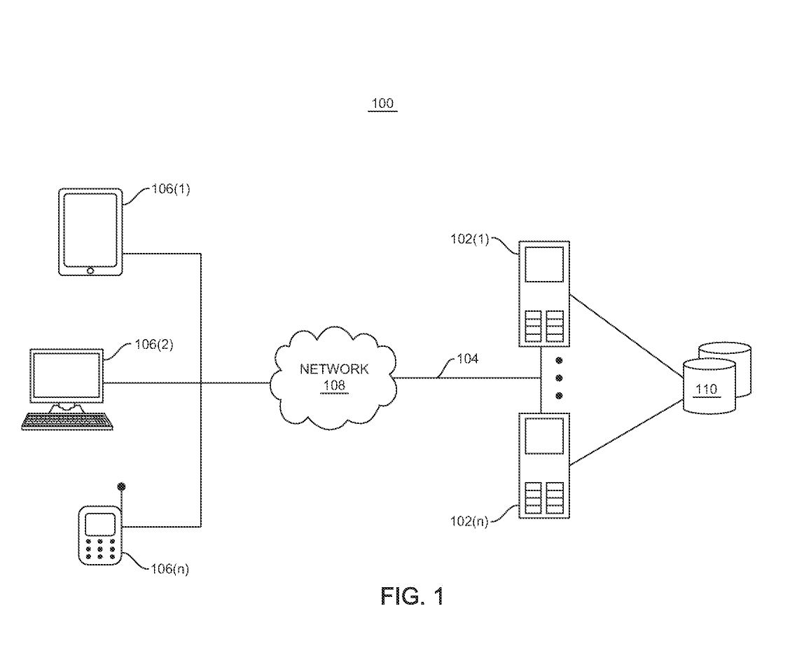

FIG. 1 is a diagram of an example system environment that includes one or more computing devices configured to perform the inventive subject matter so accordance with an aspect of the present disclosure. The example system environment 100 includes one or move Web and/or non Web application servers 102 (referred generally as “servers” or “server devices”), and one or more client devices 106(1)-106(n) (referred generally as client device 106) coupled to the servers 102 via a wide area network (WAN) 108 and a local area network (LAN) 104. For purposes of the description, client devices 106 and/or server devices 102 can be referred to generally as computing devices. In an aspect, the network 100 includes one or more storage databases 110 coupled to the computing devices.

Client devices 106 comprise computing devices capable of connecting to other network computing devices, such as servers 102 and/or database 110. Such connections are performed over wired and/or wireless networks, such as network 108, to send and receive data, such as for sending Web and/or non Web-based requests, receiving server responses to requests and/or performing other tasks. Non-limiting and non-exhausting examples of such client devices 106 include personal computers (e.g., desktops, laptops), tablets, smart televisions, video game devices, mobile and/or smart phones and the like. In an example, client devices 106 can run one or more Web browsers or dedicated software APIs that provide an interface for operators, such as human users, to interact with for making requests for resources to different applications and/or Web pages via the network 108, although other server resources may be requested by client devices. One or more Web-based or non Web-based applications may run on one or more of the servers 102 that provide the requested data back as one or more server responses to the one or more network devices.

The servers 102 comprise one or more computing devices capable of operating one or more Web-based and/or non Web-based applications that may be accessed by other computing devices (e.g. client devices, databases) in the environment 100. The servers 102 can provide web objects, executable instructions and/or other data representing requested resources, such as particular Web page(s), image(s) of physical objects, JavaScript and any other objects, that are responsive to the client devices' requests. The servers 102 may also perform other tasks and provide other types of resources. It should be noted that although only two servers 102 are shown in the environment 100 depicted in FIG. 1, other numbers and types of servers may be utilized in the environment 100.

One or more of the servers 102 may comprise a cluster of servers managed by one or more network traffic management devices 110. The servers 102 may he configured implement to execute any version of Microsoft® IIS server, RADIUS server, DIAMETER sewer and/or Apache® server, although other types of servers may be used. Further, additional servers may be coupled to the network 108 and many different types of applications may be available on servers coupled to the network 108.

Network 108 comprises a publicly accessible network, such as the Internet, which is connected to the computing devices 102, 106. However, the network 108 may comprise other types of private and public networks that include other devices. Communications, such as requests from clients 106 and responses from servers 102, take place over the network 108 according to standard network protocols, such as the HTTP, UDP and/or TCP/IP protocols, for example. However, the principles discussed herein are not limited to this example and can include other protocols. Further, network 108 may include local area networks (LANs) 104, wide area network (WANs), direct connections and any combination thereof, as well as other types and numbers of network types. On an interconnected set of LANs or other networks, including those based on differing architectures and protocols, routers, switches, hubs, gateways, bridges, cell towers and other intermediate network devices may act as links within and between LANs and other networks to enable messages and other data to be sent from and to computing devices. Also, communication links within and between LANs and other networks typically include twisted wire pair (e.g., Ethernet), coaxial cable, analog telephone lines, full or fractional dedicated digital lines including T1, T2, T3, and T4, Integrated Services Digital Networks (ISDNs), Digital Subscriber Lines (DSLs), wireless links including satellite links and other communications links known to those skilled in the relevant arts. In essence, the network 108 includes any communication method by which data may travel between client devices 106, servers 102, databases 110, and the like.

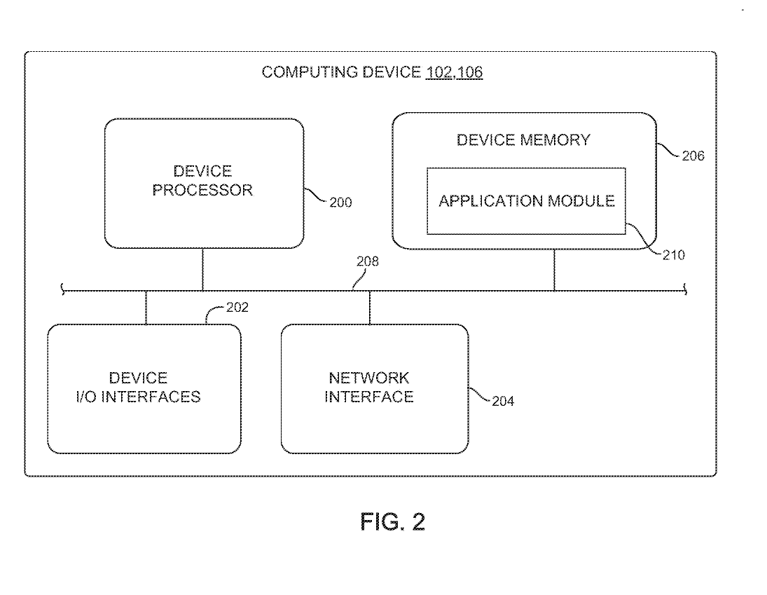

Local Area Network (LAN) 104 comprises a private local area network that allows communications between the one or more client devices 106 and one or more servers 102 in the secured network, although this is not a necessary architecture as the application module 210 (FIG. 2) can be run locally on the client device 106. Alternatively, the LAN 104 may comprise other types of private and public networks with other devices. Networks, including local area networks, besides being understood by those skilled in the relevant arts, have already been generally described above in connection with network 108 and thus will not be described further.

As per the TCP/IP protocols, requests from the requesting client device 106 may be sent as one or more streams of data packets over network 108 to the server device 102. Such protocols can be utilized by the client devices 106, the servers 102 or other computing device to establish connections, send and receive data for existing connections, and the like. In an aspect, one or more servers 102 may be hardware and/or software, and/or may represent a system with multiple servers that may include internal or external networks.

FIG. 2 is a block diagram of the computing device shown in FIG. 1 in accordance with an aspect of the present disclosure. As mentioned above, the computing device may be a client device 106 or a server device 102 which houses at least a portion of the application module 210 described in more detail below. As shown in FIG. 2, the computing device includes one or more device processors 200, one or more device I/O interfaces 202, one or more network interfaces 204, and one or more device memories 206, all of which are coupled together by bus 208. The computing device can be configured to include other types and/or numbers of components and is thus not limited to the configuration shown in FIG. 2.

Device processor 200 of the computing device comprises one or more microprocessors configured to execute computer/machine readable and executable instructions stored in the device memory 206. Such instructions, when executed by one or more processors 200, implement general and specific functions of the computing device. In addition, the instructions, when executed, enable the application module 210 to perform one or more portions of the processes described in more detail below. It is understood that the processor 200 may comprise other types and/or combinations of processors, such as digital signal processors, micro-controllers, application specific integrated circuits (“ASICs”), programmable logic devices (“PLDs”), field programmable logic devices (“FPLDs”), field programmable gate arrays (“FPGAs”), and the like. The processor 200 is programmed or configured according to the teachings as described and illustrated herein.

Device I/O interfaces 202 comprise one or more user input and output device interface mechanisms. The interface may include a computer keyboard, mouse, display device, and the corresponding physical ports and underlying supporting hardware and software to enable the computing device to communicate with other computing devices in the environment 100. Such communications may include accepting user data input and providing user output, although other types and numbers of user input and output devices may be used.

Network interface 204 comprises one or more mechanisms that enable the computing device 110 to engage in network communications over the LAN 104 and the network 108 using one or more of a number of protocols, such as TCP/IP, HTTP, UDP, RADIUS and DNS. However, it is contemplated that the network interface 204 may be constructed for use with other communication protocols and types of networks. Network interface 204 is sometimes referred to as a transceiver, transceiving device, or network interface card (NIC), which transmits and receives network data packets to one or more networks, such as the LAN 104 and the network 108. For example, where the computing device includes more than one device processor 200 for a processor 200 has more than one core), each processor 200 (and/or core) may use the same single network interface 204 or a plurality of network interfaces 204. Further, the network interface 204 may include one or more physical ports, such as Ethernet ports, to couple the computing device with other computing devices, such as servers 102. The interface 204 may also include certain physical ports dedicated to receiving and/or transmitting certain types of network data, such as device management related data for configuring the computing device or client request/server response related data.

Bits 208 may comprise one or more internal device component communication buses, links, bridges and supporting components, such as bus controllers and/or arbiters. The bus 208 enables the various components of the computing device, such as the processor 200, device I/O interfaces 202, network interface 204, and device memory 206, to communicate with one another. The bus 208 may also enable one or more components of the computing device to communicate with components in other devices as well. Example buses include HyperTransport, PCI, PCI Express, InfiniBand, USB, Firewire, Serial ATA (SATA), SCSI, IDE and AGP buses. Other types and numbers of buses may be used, whereby the particular types and arrangement of those buses will depend on the particular configuration of the computing device.

Device memory 206 comprises tangible, non-transitory, computer readable media, namely computer readable or processor readable storage media, which are examples of machine-readable storage media. Computer readable storage/machine-readable storage media may include volatile, nonvolatile, removable, and non-removable media implemented in any method or technology for storage of information. Such storage media includes computer readable/machine-executable instructions, data structures, program modules, or other data, which may be obtained and/or executed by one or more processors, such as device processor 200. Such instructions, when executed, allow or cause the processor 200 to perform actions, including performing the process described below as well as implementing an operating system for controlling the general operation of computing device.

Examples of non-transitory computer readable storage media include RAM, BIOS, ROM, EEPROM, flash/firmware memory or other memory technology, CD-ROM, digital versatile disks (DVD) or other optical storage, magnetic cassettes, magnetic tape, magnetic disk storage or other magnetic storage devices, or any other medium which can be used to store the information, which can be accessed by the computing device or specially programmed device.

As shown in FIG. 2, the computing device includes an application module 210 depicted as being within memory 206, whereby the application module 210 performs the processes described below. Although the application module 210 is shown within memory 206 in FIG. 2, the application module 210 may be alternatively located elsewhere within the computing device or among a plurality of computing devices, such as in a cloud computing environment.

In general, the application module 210 generates a laboratory report relating to a patient's health with regard to selected biomarkers for which diagnostic tests have been performed, and test result values have been obtained, for the patient. The application module 210 utilizes a user interface displayable via a computing device's screen which allows a user to enter and retrieve information. The user, such as a physician, patient, or staff, can request the application module 210 to provide a customized laboratory report showing diagnostic test result values for one or more user selected, dates on which diagnostic tests were performed on the identified patient for one or more selected biomarkers. The application module 210 is thereafter able access one or more databases and retrieve the diagnostic test result values for the identified dates for each selected biomarker. The application module 210 is also able to process the test result values and compare them with preestablished reference result value ranges for each biomarker to identify whether test result values fall within an assigned risk level. The application module 210 is thereafter able to generate the laboratory report and organize the test result values, dates, biomarkers and available risk levels in one or more cell-based charts. The application modulo 210 is also able to compile the test result values and their respective dates to generate a graph which plots the patient's test result values over time to show the changes or trends that the patient has experienced with regard to his/her test result values for each biomarker. The application module 210 may utilize unique graphical objects within the graph itself or with respect to individual cells in the chart to indicate the particular risk level that a corresponding test result value may be assigned to.

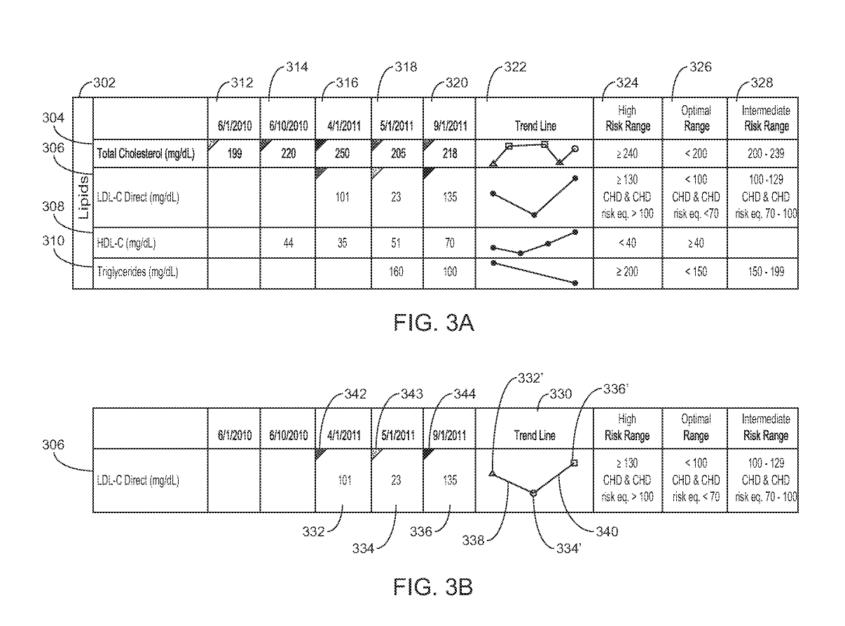

FIG. 3A illustrates an example laboratory results report for a patient for one or more health related issues. As shown in FIG. 3A, the example laboratory report 300 includes one or more sets of result report charts 302. In particular, the report 300 includes a result report chart 302 associated with test results to “lipids”, in which four biomarkers are shown to have associated diagnostic test result values that are available for the patient. It should be noted that a greater or lesser number of tested biomarkers are contemplated and that the numbers and identity of the biomarkers shown in FIG. 3A are purely exemplary. The biomarkers are organized by the application module 210 as headings to individual cell arrays. In particular, the four biomarkers are shown arranged in row-based cell arrays: Total Cholesterol 304, LDL-C Direct, 306, HDL-C 308 and Triglycerides 310. It should be noted that the biomarkers 304-310 may alternatively be arranged in column-based cell arrays.

In generating the chart 302, the application module 210 generates a plurality of cells arrays arranged to intersect the biomarker row-based cell arrays (column-based cell arrays shown in FIG. 3A). In particular to FIG. 3A, the chart 302 includes one or more individual test result data columns 312-320, a historical graph column 322, and one or more preestablished result range columns 324, 326, and 328. It should be noted that a greater or lesser number of intersecting cell arrays are contemplated and that the number and identity of the columns shown in FIG. 3A are exemplary.

The risk range column headings displayed by the application module 210 in the chart 302 contain two or more reference risk levels. In particular to FIG. 3A, the chart 302 includes three risk levels: High Risk level 324, Optimal (or Low) Risk level 326 and Intermediate Risk level 328. For each biomarker tested, the application module 210 retrieves corresponding preestablished reference result ranges or boundaries from one or more databases 110 and inserts them in the intersecting cell associated with the assigned risk level for the corresponding biomarker. It should be noted that a great or lesser number of risk levels are contemplated and that the number and identity of risk levels shown in the chart 302 are exemplary.

For example, the application module 210 inserts, for the Total Cholesterol biomarker 304, reference result range or boundary values of “≧240” for the High Risk level 324; “<200” for the Optimal Risk level 326; and “200-239” for the Intermediate Risk level 328. As shown in FIG. 3A, the reference result range values inserted into the cells associated with the High, Optimal and Intermediate risk level headers may be different based on the particular biomarker to which the risk level headers are associated with. As will be discussed in more detail below, the application module 210 may be configured to assign one or more indicator objects to the patient's test result values based on the which risk level the value falls within.

Also, as shown in FIG. 3A, the application module 210 displays one or more separate column headings based on test result values that are available for the indicated biomarkers 304-310 of the patient. In particular to FIG. 3A, the application module 210 had found patient's test result values for the indicated biomarkers 304-310 on the following dates or time periods: Jun. 1, 2010 (reference numeral 312); Jun. 10, 2010 (reference numeral 314); Apr. 1, 2011 (reference numeral 316); May 1, 2011 (reference numeral 318); and Sep. 1, 2011 (reference numeral 320). Additionally, the application module 210 inserts the retrieved diagnostic test result values in the intersecting cells based on the data of the patient's visit and the biomarker to which the result value corresponds to.

For example, for biomarker Total Cholesterol 304, the patient's diagnostic test result value inserted by the application module 210 is “199” on the Jun. 1, 2010 testing date, “220” on the Jun. 10, 2010 testing date; “250” on the Jun. 20, 2010 testing date; “205” on the Apr. 1, 2011 testing date and “218” on the Sep. 1, 2011 testing date. It should be noted that the dates or time periods are arranged subsequently in the chart 302, although this is not necessary.

The corresponding diagnostic test result values for the other identified biomarkers are also inserted by the application module 210 based on their dates of the test. As shown for dates Jun. 1, 2010 and Jun. 10, 2010 for the LDL-C biomarker 306, the application module 210 was unable to retrieve test result values from a database 110 (i.e. no diagnostic test performed on the patient for those dates). Accordingly, such intersecting cells are left blank and thus not considered by the application module 210 in generating the historical graph, as will be discussed below.

FIG. 3B illustrates a detailed view of a cell array including the historical graph for a particular biomarker in accordance with an aspect of the present disclosure. As shown in FIG. 3B, the historical reporting graph 330 is generated by the application module 210 based on the retrieved dates and corresponding diagnostic test result values for the biomarker which was tested on the patient.

In particular to the aspect shown in FIG. 3B, the application module 210 generates a graph 330 having the individual dates along an x-axis and the values of the test results along a y-axis. In another aspect, the dates and test result values are swapped along their respective axes. Although no x- or y-axis labels are shown in the graph 330, such labels may alternately be displayed.

The application module 210 assigns a graphical point to each test result value and applies the graphical points to the graph 330 with respect to the dates when the tests were performed on the patient. For example, test result value “101” in cell 332 is shown in the graph 330 as graphical point 332′. Similarly, test result value “23” in cell 334 and test result value “135” in cell 336 are shown in the graph 330 as corresponding graphical points 334′ and 336′. The application module 210 also generates one or more linear or non-linear connectors between adjacent graphical points over a time duration spanning the time periods to which the points are associated. As shown in FIG. 3B, a first connector 338 is displayed which connects points 332′ and 334′ whereas a second displayed connecter 340 connects points 334′ and 336′. The graphical points 332′, 334′, 336′ and with the connectors 338 and 340 graphically illustrate the patient's historical change or trend in LDL-C direct over the 2010-2011 time period. The changes in graph 330 of FIG. 3B show that although the patient's LDL-C had substantially decreased over the first two visits, the patient's LDL-C has substantially increased over the last two visits. The patient and physician can use the graph 330 and investigate why the patient's LDL-C went up so dramatically.

In an aspect, the application module 210 can configure one or more graphical points to be uniquely shaped (e.g. triangular, square, oval circular), colored (e.g., red, yellow, green), a combination thereof, and the like, based on the risk level that the test result value is found to be assigned to. These uniquely shaped graphical points can be incorporated by the application module 210 to be in the graph 330. As shown in FIG. 3B, graphical point 332′ has a triangle indicator which represents the corresponding test result value is in the intermediate risk range, whereas graphical point 334′ has a circle indicator which represents the corresponding test result value is in the optimal risk range. Further, graphical point 336′ has a square indicator which represents the corresponding test result value is in the high risk range.

Another benefit is that the graphical indicators (e.g. shapes, colors) assigned to the graphical points can show whether the patient is improving or getting worse regardless of whether the trendline or connectors in the graph are going up or down. For some biomarkers, a lower score is better whereas, for other biomarkers, a higher score is better. Therefore the colors can be useful to show whether the result value is desired or undesired regardless of which way the graph is sloping.

For example, if a particular test result value is determined to be within the reference result range to be a High risk level, the application module 210 may be configured to display the graphical point for that test result value to be red (or a black on a black and white hardcopy). In the same example, if a particular test result value is determined to be within the range to be at an Intermediate risk level, the application module 210 may be configured to display the graphical point for that test result value to be yellow (or mid-gray on a black and white hardcopy). In the same example, if a particular test result value is determined to be within the range to be at an Optimal risk level, the application module 210 may be configured to display the graphical point for that test result value to be green (or a light shade of gray on a black and white hardcopy). It should be noted that other shapes and colors are contemplated and are not limited to red, yellow and/or green.

Additionally or alternatively, the application module 210 may be configured to generate and display a unique indicator object within or proximal to the cell where the test result value is displayed, wherein the indictor object corresponds to the risk level to which the test result value is identified. In an aspect, as shown in FIG. 3B, the application module 210 may apply an indicator object in the form of a triangular shaped graphical object 342, 343, 344 in one or more corners of a cell. Alternatively, the indicator object 332 may be configured to be in other shapes, as shown in FIG. 3C where the indicator object 344′ is a boundary around the cell. In an example, the indicator object 342 applied by the application module 210 is uniquely shaped and/or colored (gray-scale) based on which the risk level the test result value falls in. For example, the application module 210 may display a green (or a light shade of gray as shown in FIG. 3B) triangular corner indicator object 342 to the cell having the test result value of “101” 332, because that test value is within the Optimal risk level. In contrast, a yellow (or medium shade of gray as shown in FIG. 3B) triangular corner indicator object 343 may be displayed, because the test result value “23” in cell 334 is found to be within the Intermediate risk level. In contrast, a red (or black as shown in FIG. 3B) triangular corner indicator object 344 or red boundary 344′ may be displayed, because the test result value “135” in cell 336 is found to be within the High risk level.

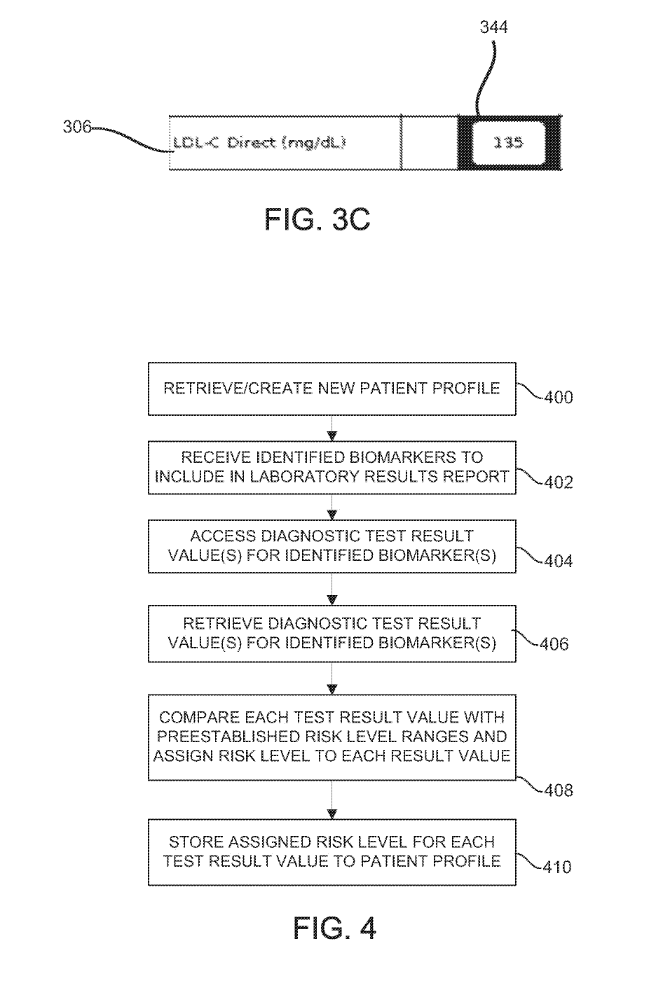

FIG. 4 illustrates an example flow chart diagram depicting portions of processes performed by the application module in accordance with an aspect of the present disclosure. As shown in FIG. 4, the process initiates where the application module receives instructions from a user, via a user interface, to retrieve or create a patient profile (Block 400).

The patient profile generally contains diagnostic information of one or more diagnostic test result values and dates or time period associated with one or more biomarkers that the patient was tested for using one or more diagnostic tests. In particular, the diagnostic information includes the type of test performed, the specific biomarker that was tested, the diagnostic test result value for that biomarker, and the time period at which the test was performed or when the diagnostic test value was obtained. For instance, the diagnostic information for an example patient would include the patient's identity (John Doe), the type of test performed (cholesterol blood test); the biomarker tested (cholesterol LDP), the diagnostic test result value (LDP=135); and the time period (Jan. 1, 2012). Other information associated with the patient profile may include the patient's name and address information, primary doctor and physician specialists currently/previously handling the patient, patient's medical history, previous diagnoses, previous surgeries, allergies previously prescribed drugs and other general and specific information regarding the patient's health.

The diagnostic information can be manually entered by a user, via the user interface, wherein the entered diagnostic information is saved to the particular patient's profile (stored in database 110 and/or other storage means). In another aspect, a diagnostic test may be performed by another physician or lab at the same or different location, whereby the diagnostic test result values may be stored in a separate memory means or database. In this aspect, the application module 210 is able to access the diagnostic information from the other memory means or database. The application module 210 may be able to store that diagnostic information in another database which also contains the patient profile information. Alternatively, the application module 210 may be configured to access the other database and retrieve the needed diagnostic information when accessing the patient's profile.

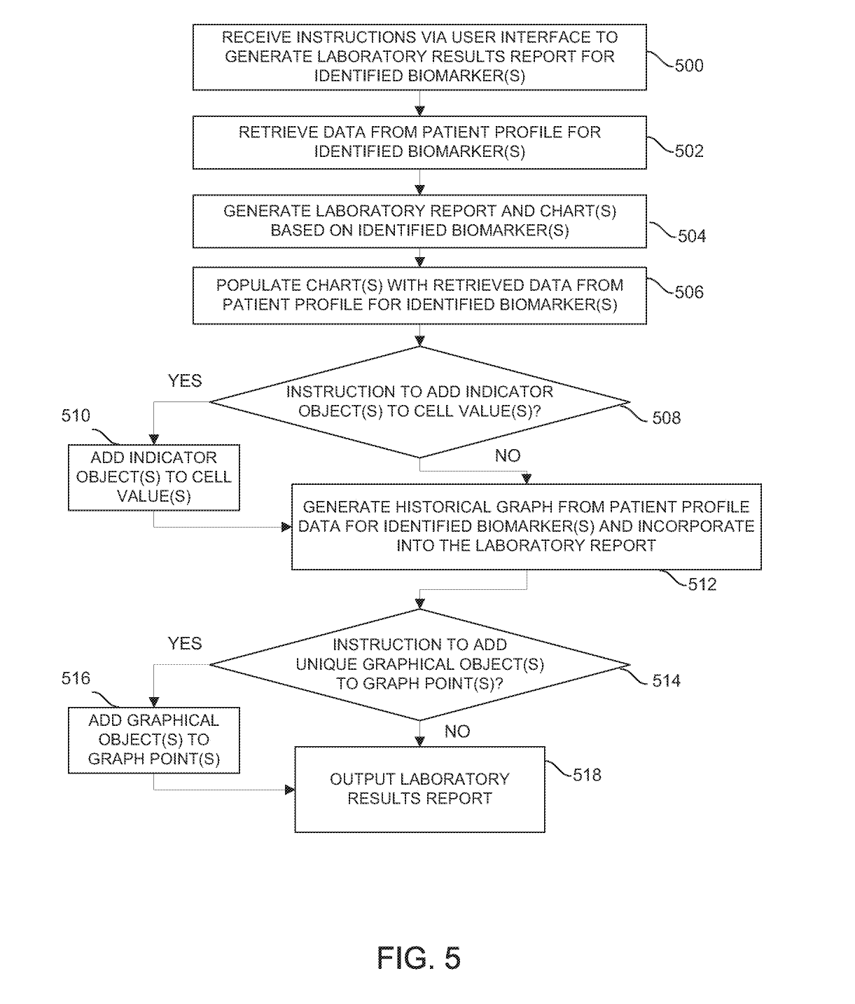

In an aspect, the application module 210, via the user interface, may request the user to select one or more biomarkers and associated diagnostic test result values are to be shown in the laboratory results report (Block 402). The application module 210 may identify which biomarkers have stored diagnostic test result value(s) and display them to the user for selection via the user interface. In particular, a user instructs the application module 210, via a user interface, to generate a laboratory results report for an identified patient. The user will identify the patient or select other appropriate information to allow the application module 210 to perform the process in FIGS. 4 and 5.

Once the user selects the diagnostic test result values that are to be on the lab results report, the application module 210 accesses the patient profile that is stored in a memory, such as database 110 or an internal memory 206 of the computing device (Block 404). It should be noted that the patient profile may alternatively be newly created by the application module 210 (i.e. new patient), whereby the application module 210 stores the new patient profile in a database or other memory means prior to accessing it in Block 404.

Once the application module 210 accesses the identified patient's profile, the application module 210 receives the one or more diagnostic test result values along with the associated time periods or dates on which the patient's diagnostic test results were determined or when the test was performed on the patient for the selected one or more biomarkers (Block 406).

Thereafter, the application module 210 compares each of the one or more retrieved test result values against preestablished risk level value ranges associated with one or more preestablished risk levels tor each biomarker (Block 408). For example, as mentioned above with respect to FIGS. 3A-3C, the preestablished result ranges for the existing risk levels are consulted by the application module 210 for each retrieved diagnostic test result value. Based on the test result value and the available reference result value ranges, the application module 210 will designate or assign each test result value to a corresponding risk level for that biomarker based on the test result value falling within a range of preestablished values. The application module 210 thereafter stores this information to the patient's profile in a memory 110, as indicated in Block 410.

FIG. 5 illustrates an example flow chart diagram depicting a portion of a process performed by the application module in accordance with an aspect of the present disclosure. As shown in FIG. 5, the process initiates in which the application module receives instructions from a user, via a user interface, to generate a laboratory results report for a patient, in which the instructions may identify the health related biomarkers that are to be included in the lab report (Block 500). In an aspect, the user may indicate, via the user interface, which testing dates are to be included in the patient's laboratory report. It is also possible for the user to select display options of the laboratory report including, but not limited to, chart layout, historical graph layout, values format and orientation, indicator objects to be applied to cells, graphical indicators to be applied to the historical graph, and the like.

Once the instructions are received, the application module 210 accesses one or more databases 110 and receives requisite data from the patient's stored profile with respect to the identified biomarkers (Block 502). Such received data may include, but not be limited to, the testing dates or time period on which one or more diagnostic tests were performed on the patient, diagnostic test result values for those testing dates, notes included by a physician and/or lab tech, preestablished risk levels and reference result value boundaries, risk levels to which biomarker test result values have been assigned or determined (by the application module 210) and the like. In other words, the application module 210 retrieves information it needs to generate the laboratory result report in the customized or preformatted form, as selected by the user. This process is repeated by the application module 210 for each testing date as well as for each identified biomarker.

The application module 210 thereafter generates the laboratory results report and integrated charts for the biomarkers identified by the user (Block 504). In this step, the application module 210 creates a number of cell arrays corresponding to the number of biomarkers that will be in the report. The application module 210 also creates a number of intersecting cell arrays corresponding to the number of test dates, risk levels, historical graphs and the like that will be in the report.

Once the chart(s) are created, the application module 210 populates the chart(s) to have appropriately placed headings and test result values (Block 506). In an example, the application module 210 will take the test result value from a test taken on the patient for testing a particular biomarker and will insert that result value in a cell in the chart which intersects the cell arrays of that test date and that particular identified biomarker. This process continues for all test dates and biomarkers that are to be included in the laboratory report.

The application module 210 will also determine whether one or more unique indicator objects are to be applied to one or more corresponding assigned cells in accordance with the user instructions (Block 508). As discussed above, some examples of the indicator objects applied to the cells can be triangular carrots 342, boundary perimeters 344′ or other graphical shapes, having color or non-color (i.e. gray-scale) indications that may be tied into the risk level to which the result value is assigned. If the user selected that indicator objects be applied to the cells, the application module 210 will add the indicator objects to the cells in accordance with the user's instructions (Block 510). In contrast, if no indicator objects are to be applied to any of the cells in the report, the process proceeds to Block 512.

Referring to FIG. 5, the application module 210 can generate a historical reporting graph 330 in the laboratory report based on the test dates and the test result values for one or more biomarkers (Block 512). As mentioned above, the application module 210 generates a graph having the selected testing dates along one axis and the values of the test results along another axis. The application module 210 assigns a graphical point to each test result value and plots the graphical paints to the graph 330 with respect to the test dates and their corresponding diagnostic test values. The application module 210 also generates one or more linear or non-linear graphical connectors between adjacent graphical points over a time duration spanning the test dates to which the points (i.e., result values) are associated. As stated above, the historical graph 330 graphically illustrates the patient's historical change or trend in a particular biomarker over the time duration when the tests were taken. This process can be repeated for each identified biomarker, wherein the application module 210 can include a plurality of historical graphs 330, one for each identified biomarker. The patient and physician can use the graph(s) 330 from viewing the laboratory report to gauge the patient's overall health for all the corresponding biomarkers identified in the laboratory report.

The application module 210 will also determine whether one or more unique graphical objects are to be applied to one or more corresponding graphical points of the historical graph in accordance with the user instructions (Block 514). In an aspect, the application module 210 can configure one or more graphical objects to be uniquely shaped (e.g. triangular, square, oval, circular), colored (e.g. red, yellow, green) or the like, based on the risk level that the rest result value is found to be assigned to. These uniquely shaped graphical objects can be incorporated by the application module 210 to be in one or more of the historical graphs (Block 516). Otherwise, the graphical points in the graph are not uniquely tied to the risk level for the corresponding result values.

Thereafter, the application module 210 generates a laboratory results report (Block 518) which can be viewed on a display screen of an electronic device or printed on physical paper as a hard copy. It should be noted that although FIG. 5 describes that the application module 210 generates a historical graph 330 as well as applies indicator objects to cells, it is contemplated the implication module 210 can be instructed to include only the historical graph 330 (without including the indicator objects applied to the cells) or vice versa.

Having thus described the basic concepts, it will be rather apparent to those skilled in the art that the foregoing detailed disclosure is intended to be presented by way of example only, and is not limiting. Various alterations, improvements, and modifications will occur and are intended to those skilled in the art, though not expressly stated herein. These alterations, improvements, and modifications are intended to be suggested hereby, and are within the spirit and scope of the examples. Additionally, the recited order of processing elements or sequences, or the use of numbers, letters, or other designations therefore, is not intended to limit the claimed processes so any order except as may be specified in the claims.

What is claimed is:

1. A method comprising:
receiving a first diagnostic test result value associated with a diagnostic test performed on a patient for a health related issue at a first time period, the corresponding diagnostic test having a plurality of risk levels, wherein each risk level has an assigned preestablished range of diagnostic test result value boundaries;
assigning the first diagnostic test result value to a first risk level based on the first diagnostic test result value falling within a first range of preestablished test result values associated with the first risk level for the diagnostic test;
receiving a second diagnostic test result value for the diagnostic test performed on the patient at a second time period, the second time period subsequent to the first time period over a first time duration;
assigning the second diagnostic test result value to a second risk level based on the second diagnostic test result value falling within a second range of preestablished test result values associated with the second risk level for the diagnostic test; and
generating, using one more processors, a reporting graph configured to illustrate one or more changes in the patient's diagnostic test result values for the health related issue tested by the diagnostic test over the first time period, the step of generating further comprising:
generating a test graphical point associated with the first test result value and a second graphical point associated with the second test result value in the reporting graph, wherein the first and second graphical points are plotted in the reporting graph based on their respective time periods and corresponding diagnostic test result values; and
generating a graphical connector in the reporting graph, wherein the graphical connector connects the first graphical point and the second graphical point over the first time duration on the report graph.

2. The method of claim 1, further comprising:
receiving a third diagnostic test result value for the diagnostic test performed on the patient at a third time period subsequent to the second time period over a second time duration;
assigning the third diagnostic test result value to a corresponding risk level based on the third diagnostic test result value being with a preestablished test result value boundaries associated with a corresponding risk level for the tested health related issue;
generating a third graphical point associated with the third test result value at the third time period in the reporting graph; and
modifying the graphical connector to connect the second graphical point and the third graphical point over the second time duration.

3. The method of claim 1, wherein at least the first risk level and the second risk level are at a same risk level.

4. The method of claim 1, wherein at least the first risk level and the second risk level are at different risk levels.

5. The method of claim 1, wherein the first graphical point is assigned to a first color preestablished with the first risk level; and the second graphical point is assigned to a second color preestablished with the second risk level.

6. The method of claim 2, wherein at least one of the graphical points has a red color, yellow color or green color.

7. The method of claim 1, wherein the graphical connector is a linear line.

8. The method of claim 1, further comprising displaying the reporting graph on a display screen of an electronic device to be viewed by an individual.

9. The method of claim 1, further comprising generating the reporting graph on a physical document.

10. The method of claim 1, wherein at least the first and second diagnostic test result values are entered by an individual via a user interface of an electronic device.

11. The method of claim 1, further comprising generating a laboratory results report for the patient, the laboratory results report including a plurality of cells arranged as a chart, wherein at least the first and second diagnostic test result values are placed in corresponding cells of the chart and organized by their respective time periods, the laboratory results report including the reporting graph within the chart.

12. The method of claim 11, wherein the first diagnostic test result value is placed in a first cell and the second diagnostic test result value is placed in a second cell, the method further comprising:
generating a first indicator object to the first cell, wherein the first indicator object is of a first color correlated with the first risk level; and
generating a second indicator object to the second cell, wherein the second indicator object is of a second color correlated with the second risk level, wherein the first and second risk levels are the same or are different.

13. The method of claim 12, wherein,
the first indicator object is triangular in shape and located in a corner of the first cell, the first indicator object being assigned to a preestablished color associated with the first risk level; and
the second indicator object is triangular in shape and located in a corner of the second cell, the second indicator object being assigned to a preestablished color associated with the second risk level.

14. A method of graphically displaying the changes in a patient's diagnostic test results and corresponding risk levels over a period of time, the method comprising:
selecting, using one or more processors, a first diagnostic test result value for a patient, the first diagnostic test result value associated with a corresponding diagnostic test performed on the patient for a health related issue at a first time period;
determining, using the one or more processors, a second level associated with the first diagnostic test result value, wherein the first diagnostic test result value is assigned to a corresponding risk level based on the value of the first diagnostic test result;
selecting, using the one or more processors, a second diagnostic test result value for the diagnostic test performed on the patient at a second time period;
determining, using the one or more processors, a risk level associated with the second diagnostic test result value, wherein the second diagnostic test result value is assigned to a corresponding risk level based on the value of the second diagnostic test result;
generating, using the one or more processors, a laboratory results report for the patient, the laboratory results report including a chart configured to include plurality of cells arranged in intersecting columns and rows, wherein at least the first and second diagnostic test result values are placed in corresponding cells of the chart and organized by their respective time periods and the corresponding health related issue tested for by the diagnostic test; and
generating, using the one or more processors, a reporting graph to be included in the chart, the reporting graph including a first graphical point associated with the first diagnostic test result value and a second graphical point associated with the second diagnostic test result value, wherein the first and second graphical points are plotted along a common time line and positioned relative to one another based on their corresponding values and time periods, the reporting graph including a graphical connector connecting the first graphical point and the second graphical point between the first and second time periods, wherein the reporting graph indicates whether the patient's health related issue has changed over diagnostic test results and risk level between the first and second time periods.

15. The method of claim 14, further comprising:
selecting a third diagnostic test result value for the diagnostic test performed on the patient at a third time period subsequent to the second time period;
determining a risk level associated with the third diagnostic test result value; and
generating a third graphical point associated with the third test result value at the third time period on the reporting graph, wherein the graphical connector is modified to connect the second graphical point and the third graphical point between the second and third time periods.

16. The method of claim 14, wherein at least the first risk level and the second risk level are at a same risk level.

17. The method of claim 14, wherein at least the first risk level and the second risk level are at different risk levels.

18. The method of claim 14, wherein the first graphical point is assigned to a first color preestablished with the first risk level; and the second graphical point is assigned to a second color preestablished with the second risk level.

19. The method of claim 14, wherein at least one of the graphical points has a red color, a yellow color or a green color.

20. The method of claim 14, wherein the graphical connector is a linear line.

21. The method of claim 14, further comprising displaying the laboratory results report and the reporting graph on a display screen of an electronic device to be viewed by an individual.

22. The method of claim 14, further comprising generating the laboratory results report and the reporting graph on a physical document.

23. The method of claim 14, wherein at least the first and second diagnostic test result values are entered by an individual via a user interface of an electronic device.

24. The method of claim 14, wherein the first diagnostic test result value is placed in a first cell of the chart and the second diagnostic test result value is placed in a second cell of the chart, the method further comprising:
applying a first indicator object to the first cell, wherein the first indicator object is of a first color correlated with the first risk level; and
applying a second indicator object to the second cell, wherein the second indicator object is of a second color correlated with the second risk level.

25. The method of claim 24, wherein,
the first indicator object is triangular in shape and located in a corner of the first cell, the first indicator object being assigned to a preestablished color associated with the first risk level; and
the second indicator object is triangular in shape and located in a corner of the second cell, the second indicator object being assigned to a preestablished color associated with the second risk level.

26. A method comprising:
selecting, using one or more processors, a first diagnostic test result value for a patient, the first diagnostic test result value associated with a corresponding diagnostic test performed on the patient for a health related issue at a first time period;
determining, using the one or more processors, a risk level associated with the first diagnostic test result value, wherein the first diagnostic test result value is assigned to a corresponding risk level based on the value of the first diagnostic test result;
selecting, using the one or more processors, a second diagnostic test result value for the diagnostic test performed on the patient at a second time period;
determining, using the one or more processors, a risk level associated with the second diagnostic test result value, wherein the second diagnostic test result value is assigned to a corresponding risk level based on the value of the second diagnostic test result;
generating, using the one or more processors, a laboratory results report for the patient, the laboratory results report including a chart configured to include plurality of cells arranged in intersecting columns and rows, wherein at least the first and second diagnostic test result values are placed in corresponding cells of the chart and organized by their respective time periods and the corresponding health related issue tested for by the diagnostic test;
displaying the first diagnostic test result value in a first cell of the chart; and
applying a first indicator object to the first cell, wherein the first indicator object is of a first color correlated with the first risk level.
